(19) United States
(12) Patent Application Publication
(10) Pub. No.: US 2010/0181178 A1
(43) Pub. Date: Jul. 22, 2010

(54) END CAP WITH SAFETY PROTECTION SWITCH

(76) Inventors: James Tseng Hsu Chang, Kowloon (HK); Hong bo Wu, Hefei (CN)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/606,848

(22) Filed: Oct. 27, 2009

(30) Foreign Application Priority Data
Jan. 22, 2009 (CN) 200920004822.1

(51) Int. Cl. H01H 13/14

(52) U.S. Cl. 200/341

(57) ABSTRACT

A protective end cap device that includes an end cap casing and a protection switch. The end cap casing includes one or two conductive pins and defines a notch located to one side of the conductive pin. The protection switch is disposed at least in part inside the end cap casing and within the notch, and includes a first switch pin and a second switch pin. The first switch pin is electrically connected to the conductive pin and the second switch pin is electrically connected to a power supply circuit board.

### PRIORITY CLAIM

The present application claims the benefit of Chinese Patent Application No. CN200920004822.1, filed Jan. 22, 2009, which is incorporated herein in its entirety by reference.

### FIELD OF THE INVENTION

The present utility model relates to the field of electrical connection protectors, and more specifically, relates to an end cap provided with a circuit-breaking function used in LED light tubes.

### BACKGROUND

The fluorescent lamp may be regarded as an important invention in the field of indoor lighting. Currently, most devices used for indoor lighting at night are fluorescent lamps. Compared to traditional light bulbs, fluorescent lamp tubes have advantages including longer service life, higher luminous efficiency, larger lighting area, and the capability to adjust the light into different light colors. The application of fluorescent lamps met the requirements of people on most occasions. At present, various kinds of electric lights are still in development. However, by the end of the 20th century, no invention that is able to meet the requirements of people better than the fluorescent lamps has ever been presented. The light-emitting diode developed in the late 20th century has brought some expectations to the future of illumination. However, since a single LED light-emitting diode has only a relatively small power which cannot meet most usage requirement, nowadays only LED light tubes, each of which consists of multiple LED light-emitting diodes, have been successfully brought into the market. Two kinds of light tubes mentioned above have occupied most of the lamp application market share. During installation of these two kinds of light tubes, two end caps are respectively configured at both ends of the light tube as the positive and negative electrodes. More particularly, in the LED light tube, since the two end caps are electrically connected, there is a very high risk of electric shock while replacing the light tube. However, none of the existing end caps in the market is equipped with any kind of protection device for addressing this problem.

### SUMMARY

The present invention aims at providing a new type of end cap protector for realizing temporary circuit-breaking protection during the process of replacing fluorescent lamps or LED light tubes and automatically closing the circuit after the installation, in order to effectively eliminate the risk of electric shock during the process of installing or disassembling the light tubes.

For achieving the technical objectives mentioned above, the present invention includes the following technical solutions: an end cap with a protection switch comprising an end cap casing, wherein one or two conductive pins are equipped on the casing. A protection switch is located inside the end cap casing, is located inside the notch of the end cap casing or located on the side of the end cap. Two metal pins of the switch are configured on this protection switch and are respectively connected to the conductive pin and the power supply circuit board.

The protection switch comprises a tubular body of the switch which has a stepped cross-section, wherein a matching cylindrical sliding bar is configured inside one end with the smaller diameter. Two metal pins of the switch configured penetrate the surface of the other end of the body of the switch. A spring contacting with one end of the sliding bar is configured between the two pins of the switch, and one end of the sliding bar while the other end of the sliding bar is connected to the sliding cap. Inside the cap there is a tubular cavity with a spring equipped inside.

In an embodiment, a notch is configured on the outer surface of the body of the switch, and an elastic fixing plate or a screw nut is configured inside the notch.

In an embodiment, a metal plate is fixed on the end surface of the sliding bar on the side of the pins of the switch.

In an embodiment, the top surface of the sliding cap is in a shape similar to a triangular pyramid formed by two inclined surfaces, wherein the sliding cap is located on the side of the conductive pin.

In an embodiment, the sliding cap has a cone-shaped or spherical top surface composed of an arc-shaped surface, wherein the sliding cap is located on the side of the conductive pin.

In an embodiment, the protection switch is a push-key type or button type switch, wherein the push-key switch is configured on the sidewall of the end cap casing.

By adopting the abovementioned technical solutions, the present utility model gains the following technical advantages and effects:

The present invention achieves the objective providing the end caps on both ends of the LED light tube with the function of circuit-breaking protection by adopting the structure with a protection switch set in the LED end cap. This function can enable the conductive pins on both ends of the LED light tube to be in the state of open circuit during the process of installing and disassembling the LED light tube so as to effectively prevent the risk of electric shock during the process of installing and disassembling the LED light tube. After installation, reconnecting the circuit in the automatic spring-control mode or manual mode can effectively prevent harm to the user during the process of installation and disassembly, and improve the safety during usage. By placing a spring-controlled protector inside the end cap casing, the present invention enables the circuit of the light tube to be automatically in the open state during installation, and forces the circuit to be automatically turned on with the pressure between the end cap and the socket after installation, namely, the final step for inserting the tube light into the light fixture. This protection function is automatically realized by the protection switch. The whole process of circuit breaking and connecting requires no deliberate control. The structure enables the present invention to effectively prevent the risk of accidental electric shock during installation and significantly improves the safety of the light-tube installation. By adopting the structure of a switch-sliding-bar, the present invention realizes the control of circuit breaking and connecting with a simple and reliable structure, thus improving the reliability of the protection switch during utilization. The function of the utilization of the sliding cap composed of inclined planes and arc surfaces has made the place for pressing the sliding cap right in the center of the sliding cap and the switch sliding bar after installation, in order to prevent shaking of the sliding bar during sliding, thereby further assuring the stability of the sliding bar during movement. The feature of a notch on the outer surface of the body of the switch coordinated with the use of the structure equipped with an elastic fixing plate enables the present invention to be fixed on the outer-casing of the end cap easily and conveniently. In conclusion, through adopting a series of technical improvements, the present invention provides a new type of anti-shock circuit-breaking protector, which can provide automatic circuit-breaking during the installation of light tubes and will automatically connect the circuit at the end of the installation. In addition to the abovementioned protection switch using automatic circuit-breaking, the present invention also provides a manual-control protection switch, which uses a push-key switch structure and controls the opening and closing of the circuit inside the LED light tube manually. The advantages of using this push-key switch or button switch as the protection switch lie in the simple structure, low costs and very reliable usage.

In summation, by adopting the series of structures mentioned above, the present invention provides a new type of light tube which is safe or to use throughout the process of installation and disassembly, and thereby thoroughly avoids the prior safety hazard that may be caused due to the fact that both ends of the LED light tube are in the closed state.

### BRIEF DESCRIPTION OF THE DRAWINGS

FIG. 1 is a front view of an embodiment of an end cap of the present invention;

FIG. 2 is a side view of the end cap of FIG. 1;

FIG. 3 is a rear view of the end cap of FIG. 1;

FIG. 4 is an A-A sectional view of the end cap of FIG. 3;

FIG. 5 is a schematic view of the protector configured on the end cap casing according to an embodiment of the present invention;

FIG. 6 is a front view of the scheme adopting the structure of a push-key type protection switch according to an embodiment of the present invention;

FIG. 7 is a side view of the scheme adopting the structure of push-key type protection switch according to an embodiment of the present invention.

### DETAILED DESCRIPTION

The present invention is further detailed in combination with the drawings.

The present invention is realized by the improvement based on an end cap used by fluorescent tubes or LED light tubes. Two kinds of protection switches with different structures are disclosed in the present invention, wherein one is a protection switch provided with the function of automatic circuit-breaking, and the other is a protection switch that requires the user to break the circuit manually. Both of the switches can achieve the objective of breaking the circuit during the process of installation or disassembly to protect the users.

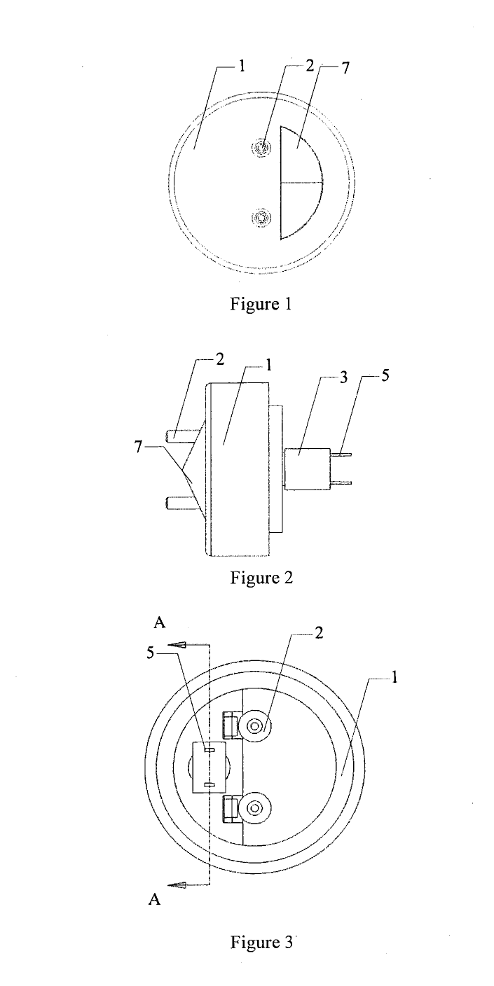

As shown in FIGS. 1-3, content of a technical improvement of the first kind of protection switch provided with the function of automatic circuit-breaking is to configure an additional protector inside the end cap to control the switching of the circuit. Its structure includes the end cap casing 1, wherein one or two conductive pins are configured on the end cap casing 1 for the electrical connection between fluorescent lamp tubes or LED light tubes. Technical improvements that have been made are to configure a protection switch inside the end cap casing 1, wherein the protection switch is configured inside the notch of the end cap casing 1, and the notch is located on one side of the conductive pin 2.

The protection switch includes a tubular body of the switch 3 which has a stepped cross-section. A matching cylindrical sliding bar 4 having a smaller diameter than the tubular body is configured inside the body. The shapes of the cross-sections of the sliding bar 4 and the matching body of the switch 3 shall be matched with each other. The body of the switch can be designed in any shape that can guarantee the normal sliding of the switch sliding bar 4 inside it, thus realizing the conduction of the circuit between the two pins of the switch 5 by a metal plate. Two pins of the switch 5 penetrating the surface of one end of the body of the switch 3, and a metal plate is fixed on the end surface of the sliding bar 4.

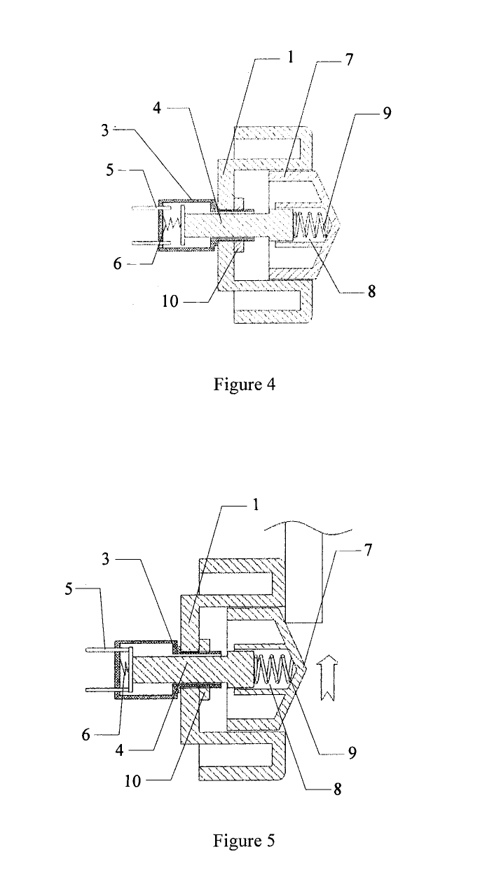

As shown in FIG. 4, the surface of one end of the body of the switch 3 is closed, with two metal pins 5 penetrating it. The spring 6 contacting with the sliding bar 4 is configured between the two pins of the switch 5, and is used for making the switch sliding bar 4 uplift a certain distance under the action of the spring 6 while it is in the free state, thus forming an open circuit between the two pins of the switch 5. The other end of the switch sliding bar 4 is connected to the sliding cap 7, which contains a tubular cavity 8 inside; a spring 9 is configured inside the cavity 8. One end of the switch sliding bar 4 is located inside the tubular cavity 8 contacting with the spring 9. During utilization, when the sliding cap 7 pushes down under the pressure of the light tube, the switch sliding bar 4 starts to glide under the force of the spring 9, and will finally contact with the two pins of the switch 5 and turn on the circuit.

Meanwhile, under the pressure of the spring 9, the switch sliding bar 4 can have very steady contact on the two pins of the switch 5. The sliding cap 7 has two structural forms, one is in the shape similar to a triangular pyramid formed by two inclined surfaces on the top wherein the sliding cap 7 is located on one side of the conductive pin 2, the other is in the shape similar to a cone formed by arc-shaped surface on the top, wherein the sliding cap 7 is also located on one side of the conductive pin 2. The vertex of the sliding cap 7 with the two structural forms is right located at the axis position of the switch sliding bar 4 in order to ensure that the switch sliding bar 4 will not shake while gliding.

As shown in FIG. 5, for the implementation of the switch in the end cap, the structure of the end cap is redesigned for installing the switch protector, thus fixing the body of the switch 3 onto the end cap casing 1. The fixing method utilizes a notch on the outer surface of the body of the switch 3, wherein the notch is ring-shaped and contains an elastic fixing plate 10 inside it for fixing the body of the switch. In this way, the entire protector can be fixed on the end cap casing 1 by the elastic fixed plate 10. The body of the switch 3 is fixed on the end cap casing 1 using thread on the switch body and a matching nut.

During utilization and installation, first the body of the switch 3 is fixed on the end cap casing 1 with the switch fixing plate 10, then the spring 9 is placed into tubular cavity 8 of the sliding cap 7. The sliding cap 7 is pushed into the end cap casing 1; the spring 9 is right in the position for holding up against the switch sliding bar 4. One electrical wire connects one of the pin of the switch 5 to conductive pin 2, another wire from the other pin of switch 5 provides electrical connection to the LEDs inside the tube. Before installing the light tube, the switch sliding bar 4 is in the state of free open circuit, as shown in FIG. 4. The two pins of the switch 5 are disconnected. In this state, the current on the light tube cannot reach the conductive pin 2 of the end cap. While installing the end cap casing 1 of the light tube, one end of the light tube will squeeze the sliding cap 7, and thereby squeeze the switch sliding bar 4 with the spring 9, and realize the electric connection between the two pins of the switch 5. As shown in FIG. 5, before realizing the electric connection with the conductive pin 2 on the end cap, the pin of the switch 5 shall be connected firstly, and then the conductive pin 2 on the end cap will be connected. When the sliding cap 7 is in a free state, the switch is in the state of open circuit, and now the other end of the end cap is not electrified. While pressing the sliding cap 7, the switch sliding bar 4 and the pins of the switch 5 will be closed, and the electric connection of the end cap will automatically be realized.

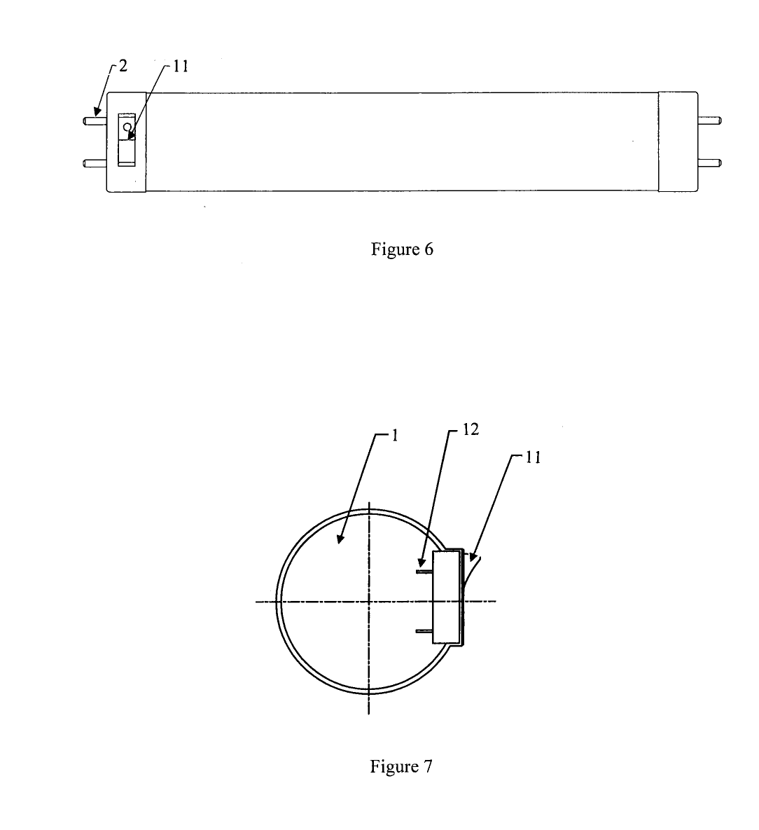

As shown in FIG. 6 and FIG. 7, this is another structure for the present utility model using a protection switch in the LED light tube, which is mainly realized by setting a push-key switch 11 on the sidewall of the end cap casing 1, wherein the two pins 12 of the push-key switch 11 are respectively connected electrically with the conductive pin 2 and the power supply board. By adopting this structure, the opening and closing of the circuit between the conductive pins 2 and pin 12 can be controlled manually. While installing and disassembling the LED light tube, the protection switch can be set to the state of open circuit by pressing the button, which also makes the conductive pin 2 in the state of open circuit, thus the installation and disassembling of the LED light tube will be assured to be quite safe. Even contacting the conductive pin 2 will not cause any risk of electric shock. After installation or disassembly, pressing the push-key switch again sets the protection switch to the state of closed circuit, such that the circuit between the conductive pins 2 is closed, and the light tube can be used normally. Although the present invention has been disclosed as the embodiments as shown above, it is not intended to limit this invention. However, it will be allowed to those skilled in the art to understand the improvements made according to the present invention without deviating from the spirit or scope of the invention. Those skilled in the art may make some modification and variation without deviating from the spirit or scope of the invention. Therefore, the scope of protection of this invention shall be subject to that defined by the claims.

What is claimed is:

1. A protective end cap device, comprising:
an end cap casing including one or two conductive pins and defining a notch located to one side of one or two conductive pins; and
a protection switch disposed at least in part inside the end cap casing and within the notch, the protection switch including a first switch pin and a second switch pin, the first switch pin electrically connected to the conductive pin and the second switch pin electrically connected to a power supply circuit board.

2. The protective end cap device of claim 1, wherein the protection switch further includes:
a tubular switch body;
a matching cylindrical sliding bar having an inward end and an outward end;
a first spring in forcible contact with the inward end of the sliding bar and disposed between the first and the second switch pins,
a sliding cap coupled to the outward end of the sliding bar, the sliding cap defining a tubular cavity having a second spring in forcible contact with the sliding cap and the outward end of the sliding bar; and
wherein the first and second switch pins penetrate an end surface of the larger diameter portion of the switch body.

3. The protective end cap device of claim 1, wherein the notch is configured on the outer surface of a switch body and a fixing plate or a screw nut or two screws are configured inside the notch.

4. The protective end cap device of claim 2, wherein the protection switch further includes a metal plate fixed on the inward end of the sliding bar on the side of the switch pins.

5. The protective end cap device of claim 2, wherein a top surface of the sliding cap defines a shape similar to a triangular pyramid formed by two inclined surfaces, and wherein the sliding cap is located on one side of the conductive pin.

6. The protective end cap device of claim 2, wherein the top of the sliding cap defines a shape similar to a cone or a spherical surface formed by an arc-shaped surface, and wherein the sliding cap is located on one side of the conductive pin.

7. The protective end cap device of claim 1, wherein the protection switch is a push-key type or button type switch, and wherein the protection switch is disposed on a sidewall of the end cap casing.
